(19) United States
(12) Patent Application Publication
(10) Pub. No.: US 2004/0214083 A1
(43) Pub. Date: Oct. 28, 2004

(54) Nickel-metal hydride storage battery and method for producing negative electrode thereof

(75) Inventors: Soryu Nakayama, Atsugi (JP); Takashi Okawa, Fujisawa (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/801,637

(22) Filed: Mar. 17, 2004

(30) Foreign Application Priority Data
Apr. 28, 2003 (JP) 2003-124113

(51) Int. Cl. H01M 4/62; H01M 4/58; B05D 5/12

(52) U.S. Cl. 429/217; 429/218.2; 427/123

(57) ABSTRACT

A dispersion of fluorocarbon resin in single particle state comprising a mixture of a liquid solvent and fluorocarbon resin particles is sprayed or coated on both sides of a negative electrode mainly composed of a hydrogen absorbing alloy to form a fluorocarbon resin layer in single particle state on both sides of the negative electrode.

### BACKGROUND OF THE INVENTION

1. Field of the Invention

The present invention relates to a nickel-metal hydride storage battery, and particularly the present invention improves the negative electrode to inhibit increase of inner pressure of the battery during overcharging.

2. Description of Related Art

Recently, demand for nickel-metal hydride storage batteries has expanded because they do not adversely affect the environment and have high energy density. The nickel-metal hydride storage batteries are employed as electric sources of various cordless equipment and electronic equipment. Furthermore, they are employed for electric tools and electric cars which require high rate charging and discharging, and these are commercialized. With expansion of the demand for nickel-metal hydride storage batteries, high rate charging and discharging, higher capacity and longer life of the batteries are further demanded.

In nickel-metal hydride storage batteries which use negative electrodes containing hydrogen absorbing alloy powders, oxygen gas is generated from positive electrodes by the reaction shown by the following formula (1) at the end of charging or at the time of overcharging.

OH⁻→½H₂O+¼O2+e⁻ (1)

The oxygen generated in this reaction passes through a separator and reaches negative electrode, and is consumed by the reactions shown by the following formulas (2) and (3) (in which M denotes a hydrogen absorbing alloy and MH denotes a hydrogen absorbing alloy in the state of occluding hydrogen, namely, a metal hydride compound).

½O₂+H₂O+2e⁻→2OH⁻ (2)

MH+¼O₂→M+½H₂O (3)

If the reaction of the oxygen gas with hydrogen occluded in the hydrogen absorbing alloy does not rapidly proceed and the reaction for consumption of oxygen gas is not rapidly carried out, the rate of generation of oxygen gas from the positive electrode exceeds the rate of consumption of oxygen gas at the negative electrode, and hence the inner pressure of the battery increases. When the inner pressure of the battery exceeds the working pressure of safety valve, the safety valve opens to permit escape of the gas in the battery. In this case, sometimes the electrolyte is also released from the battery simultaneously with the escape of the gas, which causes shortage of electrolyte.

As a result, cycle life of batteries shortens. This problem is particularly serious in the case of carrying out the high rate charging.

In order to inhibit increase of the inner pressure of batteries, it has been proposed to provide a water repellent layer comprising a fluorocarbon resin powders on the surface of the negative electrode to expedite absorption of oxygen gas at the negative electrode (see page 2 of JP-A-5-242908).

According to the above method, water repellency of the surface of the negative electrode is improved by using a water repellent fluorocarbon resin on the surface of the negative electrode. Thus, the surface of negative electrode and oxygen gas readily contact with each other and the gas absorption reaction proceeds rapidly to inhibit increase of inner pressure.

### DISCLOSURE OF THE INVENTION

However, in the above proposals, the absorbability of oxygen gas is improved, but various problems occur simultaneously. That is, primary particles of the fluorocarbon resin agglomerate even when they have a particle diameter of less than 1 μm, and hence they become agglomerated particles of several ten μm. If a layer comprising agglomerated particles of fluorocarbon resin having a particle diameter of several ten μm is formed on the surface of a negative electrode, distribution of electrolyte on the surface of negative electrode becomes uneven to cause reduction of gas consumption reaction.

Furthermore, agglomerated particles of fluorocarbon resin have a large size and are apt to fall off from the surface of negative electrode.

Moreover, when positive electrodes, negative electrodes and separators are combined and rolled into a spiral form, the surface of the electrodes receive a pressure and the agglomerated particles of fluorocarbon resin are ruptured to form a film and to increase unevenness of distribution of electrolyte on the surface of negative electrode.

The present invention solves the above problems, and the object of the present invention is to provide a negative electrode the surface of which is kept uniform in water repellency and in which the oxygen gas absorption reaction satisfactorily takes place on the hydrogen absorbing alloy when overcharging the battery, and a method for producing the negative electrode, and a nickel-metal hydride storage battery having the negative electrode.

According to the present invention to attain the above object, a fluorocarbon resin in a single particle state is present on the surface of a negative electrode in a nickel-metal hydride storage battery which comprises negative electrodes, positive electrodes, separators and an alkaline electrolyte.

The fluorocarbon resin preferably has a particle diameter of not more than 2.0 μm.

The amount of the fluorocarbon resin is preferably 0.0005-0.005 g per 1 cm² of the negative electrode.

The method for producing the negative electrode includes a step of forming a hydrogen absorbing alloy layer on both sides of an electrically conductive support by coating hydrogen absorbing alloy powders on both sides of the support, drying the coat and pressing the coated support, a step of preparing a dispersion of fluorocarbon resin in single particle state by mixing a mixed liquid comprising fluorocarbon resin particles and a liquid solvent to collapse the agglomeration of the particles, thereby dispersing the particles in single particle state, and a step of spraying or coating the dispersion of the fluorocarbon resin particles in single particle state on the surface of both the hydrogen absorbing alloy layers and drying the sprayed dispersion.

For carrying out the mixing, a high-speed mixer and an ultrasonic homogenizer are preferably used. These methods are preferred because the dispersibility increases and the agglomerated particles can be collapsed. It is more preferred to add a surface active agent to the mixed liquid.

By making a nickel-metal hydride storage battery using the resulting negative electrode, too much increase of the inner pressure of the battery during the overcharging can be inhibited.

### BRIEF DESCRIPTION OF DRAWINGS

FIG. 1 is a schematic sectional view of a negative electrode in one example of the present invention.

FIG. 2 is an oblique view of a nickel-metal hydride storage battery in one example of the present invention, shown partly disassembled.

FIG. 3 is a schematic sectional view which shows one example of the negative electrode of a comparative example.

FIG. 4 is a schematic sectional view which shows one example of the negative electrode of a comparative example.

### DESCRIPTION OF THE PREFERRED EMBODIMENTS

The embodiments of the present invention will be explained below.

Embodiment 1: Negative electrode for nickel-metal hydride storage battery

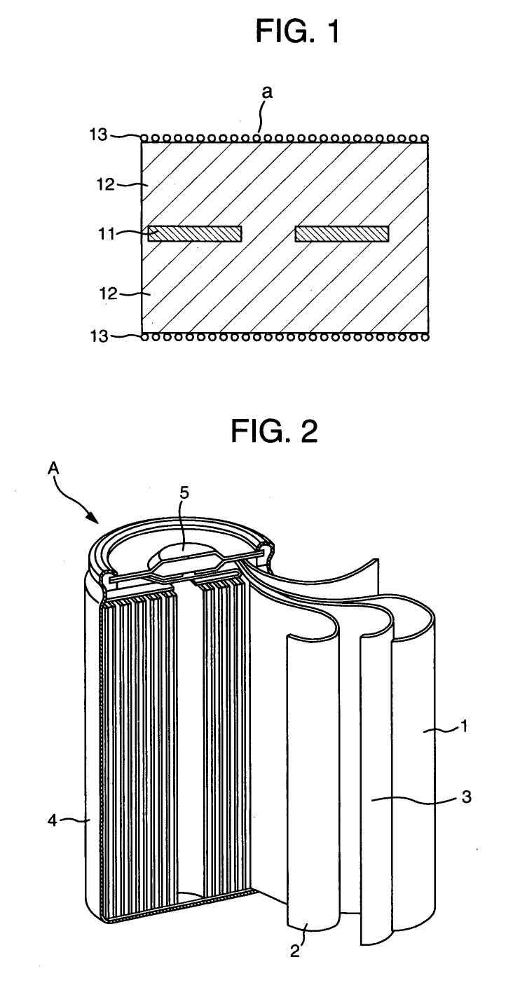

FIG. 1 shows a schematic sectional view in width direction of the negative electrode (a) for nickel-metal hydride storage battery in Embodiment 1.

The negative electrode (a) comprises an electrically conductive support 11, a layer 12 which contains a hydrogen absorbing alloy and is supported on both sides of the support 11, and a fluorocarbon resin particle layer 13 on the surface of the layer 12.

As the support 11, there may be used, for example, a punching metal comprising nickel, nickel-plated iron, or the like.

The layer 12 contains at least a hydrogen absorbing alloy and a conducting agent such as carbon black. As the hydrogen absorbing alloy, there may be used an alloy generally used for nickel-metal hydride storage battery, for example, an alloy containing Mm (Misch metal: a mixture of rare earth elements) and nickel.

As the fluorocarbon resin, there may be used the commercially available PTFE (polytetrafluoroethylene), FEP (a copolymer of tetrafluoroethylene and hexafluoropropylene) or the like. The shape of the fluorocarbon resin particles varies depending on the production method, and preferred is nearly spherical shape. The term “nearly spherical shape” includes spherical shape, almost spherical shape, oval shape, egg shape, or the like.

The particle diameter of the fluorocarbon resin particles is not more than 2.0 μm, and preferably 0.05-1.0 μm. When the particle diameter is smaller, a dense film-like layer is apt to be formed on the surface of the hydrogen absorbing alloy negative electrode, and as a result, wettability of the surface of the negative electrode with liquid becomes low, and the amount of hydrogen present in the surface portion of the electrode decreases to cause deterioration of absorbability of oxygen gas. If the particle diameter is more than 2.0 μm, distribution of the electrolyte on the surface of the hydrogen absorbing alloy negative electrode is apt to become uneven, resulting in deterioration of absorbability of oxygen gas. The amount of the fluorocarbon resin particles is preferably 0.0005-0.005 g, more preferably 0.001-0.004 g per 1 cm² of the negative electrode. If the amount of the fluorocarbon resin particles is less than 0.0005 g, a three-phase interface of liquid, solid and gas would not be sufficiently formed on the surface of the negative electrode, and gas absorbability sometimes would not be sufficiently exhibited. If the amount of the fluorocarbon resin particles is more than 0.005 g, wettability of the surface of the negative electrode with liquid would be too low, and the amount of hydrogen present in the surface portion of the negative electrode would be small, sometimes resulting in deterioration of absorbability of oxygen gas.

As mentioned above, when a fluorocarbon resin layer in the state of single particles of nearly spherical shape is provided on the outermost surface of the negative electrode, improvement of consumability of oxygen gas can be attained for the following reasons.

Oxygen gas generated from a positive electrode is consumed in accordance with the reaction represented by the formula (3). That is, in order to perform rapidly the oxygen gas absorption reaction, it is important that a three-phase interface of alloy, electrolyte and oxygen gas, and hydrogen absorbed in the alloy are allowed to be present on the surface of the negative electrode in the state of an interface of the oxygen gas and the surface of the electrode and an interface of the oxygen gas and the electrolyte being present.

When a fluorocarbon resin layer in the single particle state is provided on the outermost surface of the negative electrode, the water repellency given by the fluorocarbon resin particles becomes satisfactory, and a uniform three-phase interface of alloy, electrolyte and oxygen gas is sufficiently formed on the surface of the negative electrode, whereby absorption of oxygen gas in accordance with the reaction shown by the formula (3) is smoothly performed.

Furthermore, it is preferred that a fluorocarbon resin layer in the state of single particles of nearly spherical shape is provided on the surface of the negative electrode, but small agglomerated particles may be present in a small amount. For example, the small agglomerated particles may be present in an amount of not more than 30% by weight, preferably not more than 20% by weight based on the fluorocarbon resin as far as the exertion of the effect of the present invention to inhibit the increase of inner pressure is not hindered. Preferably the particle diameter of the agglomerated particles is 2.0 μm or less.

Embodiment 2: Method for the Preparation of Fluorocarbon Resin Dispersion

According to the method for the preparation of the fluorocarbon resin dispersion of Embodiment 2, fluorocarbon resin particles are mixed with a liquid solvent, and the fluorocarbon resin is dispersed, thereby collapsing the agglomerated particles and dispersing the particles in single particle state to prepare a fluorocarbon resin dispersion in single particle state. The liquid solvent is preferably an organic solvent, and examples thereof are those which are generally commercially available, such as toluene, methanol and ethanol. A mixed solvent may be used.

As a method for mixing the mixed liquid, preferred is a method which comprises stirring the mixed liquid and dispersing the fluorocarbon resin particles in the liquid solvent by a high-speed mixer or an ultrasonic homogenizer. Besides, there may be employed a method of adding a surface active agent to the liquid solvent subsequently adding the fluorocarbon resin particles and then stirring the mixed liquid and dispersing the fluorocarbon resin particles in the liquid solvent by a high-speed mixer or an ultrasonic homogenizer. The surface active agent is not particularly limited so long as it does not affect the battery characteristics, and there may be used generally commercially available surface active agents such as sodium dodecylbenzenesulfonate and sodium alkylnaphthalenesulfonate.

Embodiment 3: Method for Producing a Negative Electrode for Nickel-Metal Hydride Storage Batteries

According to the method for producing the negative electrode, first a layer containing a hydrogen absorbing alloy is formed on an electrically conductive support. This layer can be formed by coating a paste containing the hydrogen absorbing alloy on the support, followed by drying and rolling. The paste can be prepared by kneading the hydrogen absorbing alloy and water together with a conducting agent, a thickening agent or the like.

Next, a dispersion comprising a mixture of an organic solvent and fluorocarbon resin particles is sprayed or coated on both sides of the layers containing the hydrogen absorbing alloy, followed by drying.

According to the methods of Embodiments 2 and 3, the negative electrode explained in Embodiment 1 can be easily produced.

Embodiment 4: Nickel-Metal Hydride Storage Battery.

FIG. 2 illustrates an oblique view of the nickel-metal hydride storage battery of Embodiment 4, shown partly disassembled.

In FIG. 2, the nickel-metal hydride storage battery A is made by rolling into a spiral the positive electrode 2, the negative electrode 1, and separator 3 which is interposed between the positive electrode and the negative electrode and electrically insulate them, thereby forming a plate group, inserting the plate group into a battery case 4, pouring an alkaline electrode in the case, and then sealing the case at its top portion with a sealing plate 5 which also acts as a positive electrode terminal.

As the negative electrode 1, the negative electrode of Embodiment 1 produced by the method of Embodiment 3 is used. As the positive electrode 2, the separator 3, the case 4 and the electrolyte, there may be used those which are generally used for alkaline storage batteries.

Since the negative electrode of the present invention is used in the nickel-metal hydride storage battery of the present invention, too much increase of the inner pressure of the battery during overcharging and high rate charging can be inhibited.

The present invention will be explained in detail by the following examples, which should not be construed as limiting the invention in any manner, and the invention can be worked with optional modifications without changing the scope of the invention.

### EXAMPLE 1

A hydrogen absorbing alloy having a composition represented by MmNi_{3.55}CO_{0.75}Mn_{0.4}Al_{0.3} (Mm: a mixture of rare earth elements) was pulverized by a ball mill to obtain powders having an average particle diameter of 24 μm. Thereafter, 100 parts by weight of the resulting hydrogen absorbing alloy powders, 0.15 part by weight of carboxymethyl cellulose which functions as a thickening agent, 0.3 part by weight of carbon black which functions as a conducting agent, and 0.8 part by weight of a styrene-butadiene copolymer which functions as a binder were mixed with water which was a dispersing medium to prepare a hydrogen absorbing alloy paste. This paste was coated on a punching metal which was the support 11, followed by drying and rolling.

Next, nearly spherical PTFE particles having a particle diameter of 0.1-0.3 μm and an average particle diameter of 0.2 μm were added to ethanol which was a liquid solvent at a specific proportion, and the mixture a fluorocarbon resin dispersion in single particle state was prepared by an ultrasonic homogenizer. The average particle diameter (radian diameter) was measured by a particle size distribution measuring device (LA-920 manufactured by HORIBA). The average particle diameter was 0.2 μm. Presence of particles having a particle diameter exceeding 2 μm was not recognized by observation under an electron microscope.

The dispersion was sprayed on both sides of the above base electrode plate by a two-hydraulic nozzle manufactured by IKEUCHI Co., Ltd. so that the amount of the fluorocarbon resin particles on the base electrode plate was 0.002 g per cm². Then, the base electrode plate was dried and cut to 3.5 cm in width and 31 cm in length to produce a hydrogen absorbing alloy negative electrode (a) in Example 1 of the present invention. The thickness of the electrode (a) was 0.33 mm.

FIG. 1 shows a schematic sectional view of the negative electrode (a) in width direction.

Next, the negative electrode (a), positive electrode and separator interposed between the electrodes which electrically insulates them were rolled into a spiral to form a plate group. This plate group was inserted into a battery case of SC size, an alkaline electrolyte was poured in the case, and then the case was sealed at its top portion with a sealing plate which also served as a positive terminal to obtain a nickel-metal hydride storage battery A of the present invention which had a nominal capacity of 3000 mAh.

As the positive electrode, a known paste type nickel positive electrode of 3.5 cm in width, 26 cm in length and 0.57 mm in thickness was used; as the separator, a nonwoven fabric made of polypropylene having hydrophilic groups was used; and as the electrolyte, an electrolyte prepared by dissolving lithium hydroxide at a proportion of 40 g/L in an aqueous potassium hydroxide solution having a specific gravity of 1.30 was used.

### COMPARATIVE EXAMPLE 1

In Comparative Example 1, a nickel-metal hydride storage battery B was produced which differed from the battery A only in the state of the fluorocarbon resin coated on the surface of the negative electrode. Specifically, nearly spherical PTFE particles having a particle diameter of 0.1-0.3 μm and an average particle diameter of 0.2 μm were added to ethanol which was a liquid solvent at a specific proportion, and a fluorocarbon resin dispersion was prepared by stirring and dispersing with a propeller type stirrer which was a usual dispersing method. Since the fluorocarbon resin particles in this state were in the form of agglomerated particles, the average particle diameter was about 60 μm. FIG. 3 shows a schematic sectional view of the negative electrode (b) of this battery in the direction of electrode.

### COMPARATIVE EXAMPLE 2

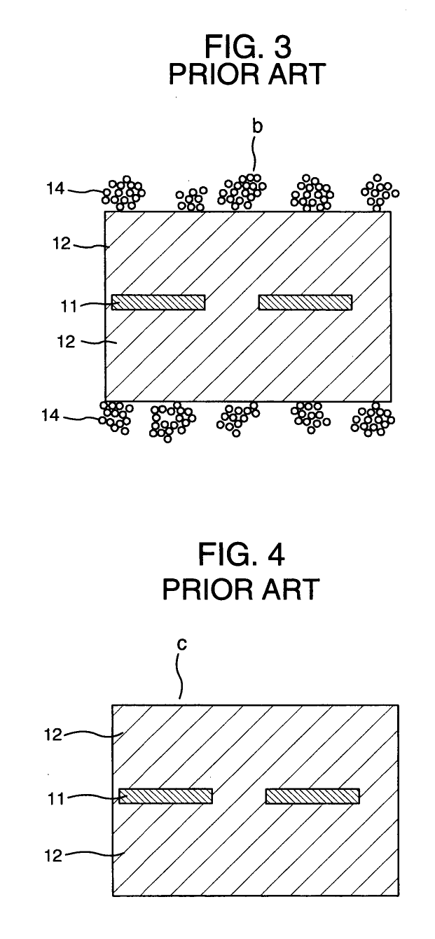

In Comparative Example 2, a nickel-metal hydride storage battery C was produced which was the same as the battery A of Example 1, except that the negative electrode was not coated with any materials. FIG. 4 shows a schematic sectional view of the negative electrode (c) of this battery in the direction of electrode.

### EXAMPLE 2

In Example 2, battery characteristics were examined in the case of changing the amount of the fluorocarbon resin particles coated on the base electrode plate in Example 1. A base electrode plate was produced under the same conditions as in Example 1, and then hydrogen absorbing alloy negative electrodes (d1)-(d7) were produced with changing the coating amount of the fluorocarbon resin particles as shown in Table 1. Using these negative electrodes (d1)-(d7), sealed nickel-metal hydride storage batteries D1-D7 were produced in the same manner as in Example 1.

### COMPARATIVE EXAMPLE 3

In Comparative Example 3, hydrogen absorbing alloy negative electrodes (e1)-(e7) were produced in the same manner as in Comparative Example 1, except that the coating amount of the fluorocarbon resin coated on the surface of the negative electrode was changed as shown in Table 1. Using these negative electrodes (e1)-(e7), nickel-metal hydride storage batteries E1-E7 were produced in the same manner as in Example 1. Specifically, nearly spherical PTFE particles having a particle diameter of 0.1-0.3 μm and an average particle diameter of 0.2 μm were added to ethanol which was a liquid solvent at a specific proportion, and a fluorocarbon resin dispersion was prepared by stirring and dispersing with a propeller type stirrer which was a usual dispersing method. Since the fluorocarbon resin particles in this state were in the form of agglomerated particles, the average particle diameter was about 60 μm.

(Evaluation of Characteristics of Batteries)

Each of the battery A of Example 1, the battery B of Comparative Example 1, the battery C of Comparative Example 2, the batteries D of Example 2, and the batteries E of Comparative Example 3 was left to stand at 25° C. for 1 day after fabrication of the battery. Thereafter, the battery was subjected to two charging and discharging cycles, one cycle of which comprised charging the battery at 300 mA for 15 hours at 20° C., and then discharging the battery at 600 mA until the terminal voltage of the battery reached 1.0 V. In this way, the battery was subjected to initial activation, and the inner pressure characteristics of the battery were evaluated.

The inner pressure characteristics at the time of overcharging was evaluated by charging the battery at 3000 mA for 1.5 hour at 20° C., and measuring the inner pressure of the battery. The inner pressures of the batteries at the time of overcharging are shown in Table 1.

TABLE 1

| | | | | Average |
|---|---|---|---|---|
| | | Amount | Inner | particle |
| | Bat- | of PTFE | pressure | diameter after |
| | tery | (g/cm²) | (Mpa) | dispersing (μm) |
| Example 1 | A | 0.002 | 0.50 | 0.2 |
| Comparative Example 1 | B | 0.002 | 0.81 | 60 |
| Comparative Example 2 | C | — | 1.35 | — |
| Example 2-1 | D1 | 0.0002 | 0.86 | 0.2 |
| Example 2-2 | D2 | 0.0005 | 0.62 | |
| Example 2-3 | D3 | 0.001 | 0.52 | |
| Example 2-4 | D4 | 0.002 | 0.50 | |
| Example 2-5 | D5 | 0.003 | 0.55 | |
| Example 2-6 | D6 | 0.005 | 0.63 | |
| Example 2-7 | D7 | 0.007 | 0.90 | |
| Comparative Example 3-1 | E1 | 0.0002 | 1.12 | 60 |
| Comparative Example 3-2 | E2 | 0.0005 | 0.92 | |
| Comparative Example 3-3 | E3 | 0.001 | 0.89 | |
| Comparative Example 3-4 | E4 | 0.002 | 0.81 | |
| Comparative Example 3-5 | E5 | 0.003 | 0.93 | |
| Comparative Example 3-6 | E6 | 0.005 | 1.27 | |
| Comparative Example 3-7 | E7 | 0.007 | 1.62 | |

As can be seen from Table 1, in the case of battery A of Example 1, increase of the inner pressure at the time of overcharging was inhibited as compared with battery B of Comparative Example 1.

The reason why the effect to inhibit increase of the inner pressure of battery A is superior is considered that arrangement of the fluorocarbon resin particles is in a satisfactory state by providing a fluorocarbon resin layer in single particle state on the outermost surface of the negative electrode, whereby the resin film and the electrolyte on the surface of the electrode are inhibited from becoming nonuniform and hydrogen is easily absorbed into the alloy near the surface of the electrode during charging, and as a result, a three-phase interface at which the alloy, the electrolyte and oxygen gas coexist is sufficiently and more finely formed on the surface of the negative electrode, and the oxygen gas generated from the positive electrode can be smoothly absorbed.

Furthermore, as shown in Table 1, with increase in the coating amount of the PTFE particles, the gas consumption reaction readily took place on the surface of the negative electrode, and hence there was an effect to inhibit increase of inner pressure of the battery. However, if the coating amount exceeded 0.003 g/cm², the effect to inhibit increase of the inner pressure gradually lowered, and if it exceeded 0.005 g/cm², the effect to inhibit increase of the inner pressure completely lowered. It is considered that this is because increase of the coating amount of the fluorocarbon resin results in enhancement of water repelling effect at the surface of the negative electrode, which causes insufficient contact between the hydrogen absorbing alloy in the surface portion and the electrolyte and collapse of the three-phase interface structure of liquid, solid and gas on the surface of the negative electrode, and as a result, the amount of hydrogen present in the surface portion decreases and absorbability of oxygen gas by the negative electrode deteriorates. If the coating amount of the PTFE particles is less than 0.0005 g/cm², the water repelling effect of the surface of the negative electrode cannot be sufficiently exhibited, and the inner pressure cannot be sufficiently inhibited.

From the above results, the coating amount of the fluorocarbon resin particles is desirably 0.0005-0.005 g/cm².

Furthermore, in the above examples, PTFE was used as the fluorocarbon resin, but the similar effects can also be obtained by using other water repelling fluorocarbon resins such as FEP in place of PTFE. Moreover, ethanol was used as the organic solvent, but the similar effects can also be obtained by using other organic solvents such as methanol and toluene in place of ethanol.

As explained above, arrangement of the fluorocarbon resin particles is in satisfactory state by providing a fluorocarbon resin layer in single particle state on the outermost surface of the negative electrode, and there is sufficiently formed a three-phase interface comprising alloy surface, electrolyte and oxygen gas on the surface of the negative electrode.

According to the negative electrode for nickel-metal hydride storage battery and the method for producing the same of the present invention, absorption of oxygen gas generated from the positive electrode during overcharging is enhanced, and the battery can be inhibited from becoming too high in inner pressure.

What is claimed is:

1. A nickel-metal hydride storage battery comprising a negative electrode mainly composed of a hydrogen absorbing alloy, a positive electrode, a separator and an alkaline electrolyte wherein a fluorocarbon resin is present in single particle state on the surface of the negative electrode.

2. A nickel-metal hydride storage battery according to claim 1, wherein the fluorocarbon resin has a particle diameter of not more than 2.0 μm.

3. A nickel-metal hydride storage battery according to claim 1, wherein the amount of the fluorocarbon resin is 0.0005-0.005 g per 1 cm² of the negative electrode.

4. A method for producing a negative electrode for batteries which includes a step of forming a hydrogen absorbing alloy layer on both sides of an electrically conductive support by coating hydrogen absorbing alloy powders on both sides of the support, drying the coat and pressing the coated support, a step of preparing a dispersion of fluorocarbon resin in single particle state by mixing a mixed liquid comprising fluorocarbon resin particles and a liquid solvent thereby dispersing the fluorocarbon resin particles in the liquid solvent, and a step of spraying or coating the dispersion of the fluorocarbon resin particles in single particle state on the surface of both the hydrogen absorbing alloy layers and drying the resulting coat.

5. A method for producing a negative electrode for batteries according to claim 4, wherein the mixing is carried out using a high-speed mixer.

6. A method for producing a negative electrode for batteries according to claim 4, wherein the mixing is carried out using an ultrasonic homogenizer.

7. A method for producing a negative electrode for batteries according to claim 4, wherein a surface active agent is added to the mixed liquid.
